(19) United States
(12) Patent Application Publication
(10) Pub. No.: US 2004/0234733 A1
(43) Pub. Date: Nov. 25, 2004

(54) Painting sheet and a method for producing the same

(76) Inventor: Roland Bachmann, Ottoberg (CH)

Correspondence Address: Browdy & Neimark, Suite 300, 624 Ninth Street NW, Washington, DC, 20001, US

(21) Appl. No.: 10/474,257

(22) PCT Filed: Feb. 27, 2002
(86) PCT No.: PCT/CH02/00119

(30) Foreign Application Priority Data
Feb. 28, 2001 (CH) 364/01

(51) Int. Cl. B32B 3/00

(52) U.S. Cl. 428/195.1

(57) ABSTRACT

The painting sheet comprises a carrier (1) for at least one image, said carrier being for example a sheet of paper. The carrier (1) has at least one area (6) that represents one of the components of the design to be achieved. Said area (6) is configured as a half-tone template so that the area (6) appears paler or lighter than the design that is to be achieved by painting this pale image content.

The present invention relates to a painting sheet comprising a carrier for at least one design, and a method for producing the painting sheet.

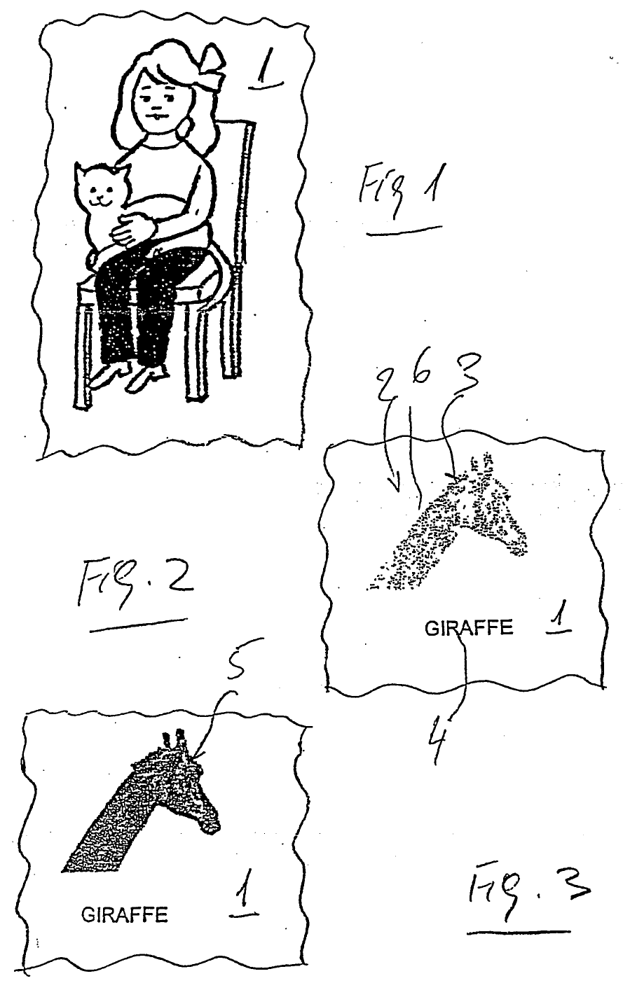

Painting sheets of this generic type are already known that make it possible to paint designs, in particular images, for example in a playful manner. The carrier used for the respective design in the case of the previously known painting sheets is a more or less white sheet of paper. One example of the execution of a design in a previously known painting sheet is reproduced in FIG. 1 of the appended drawing. The outline of the design, an image in the present case, is indicated by lines on the white paper sheet. On the white paper sheet, black lines surround regions of the white surface of the paper sheet. Within the outline of the design, partial areas of the design can be indicated by further lines. These lines also border regions of the white surface of the carrier within the design. The white paper sheet offers the advantage that colors which are applied to the paper sheet are not influenced and not impaired by the white substrate.

In the painting sheets according to the prior art, there is generally on the same carrier, beside the design to be painted, the same design again, but which has already been painted with colors by the manufacturer. This design painted by the manufacturer can be described as an original painting. The lines in this original painting have the same course as the lines in the copy to be painted. This copy to be painted can also be called the working copy. The areas lying within the lines in the original painting are painted with those colors with which the corresponding areas in the working copy are to be painted. The respective area of the original painting is covered uniformly with the relevant color.

The object of the user of such a known painting sheet is to paint the areas bordered by lines in the working original as far as possible with those colors which correspond to the colors in the relevant bordered areas of the original painting. It is a further object of the user to cover the relevant areas in the working copy with the corresponding colors from the original painting as uniformly as possible.

Such painting sheets can reproduce the designs only by means of lines. However, the natural objects do not have any borders made by lines, nor do they have any partial areas bounded by lines. In addition, the partial areas of natural objects generally do not have any uniformly colored areas, since the areas of the natural objects normally have half-tones, shadows and so on. The previously known painting sheets are able to reproduce the designs only as flat and uniformly colored or blackened areas, so that the original paintings and the working copies to be painted are able to reproduce only primitive designs. This type of painting sheet therefore does not offer any possibility of registering and reproducing for example half-tones, shadows and so on in the image. Consequently, the user of such painting sheets cannot practice painting half-tones, shadows and so on.

It is an object of the present to eliminate the aforementioned and still further disadvantages of the prior art.

In the case of the painting sheet of the generic type mentioned here by way of introduction this object is achieved, according to the invention, as defined in the characterizing part of patent claim 1.

Embodiments of the present invention will be explained in more detail below using the appended drawings, in which:

FIG. 1 shows a working copy to be painted in a painting sheet according to the prior art,

FIG. 2 shows an example for a working copy to be painted in accordance with the present invention,

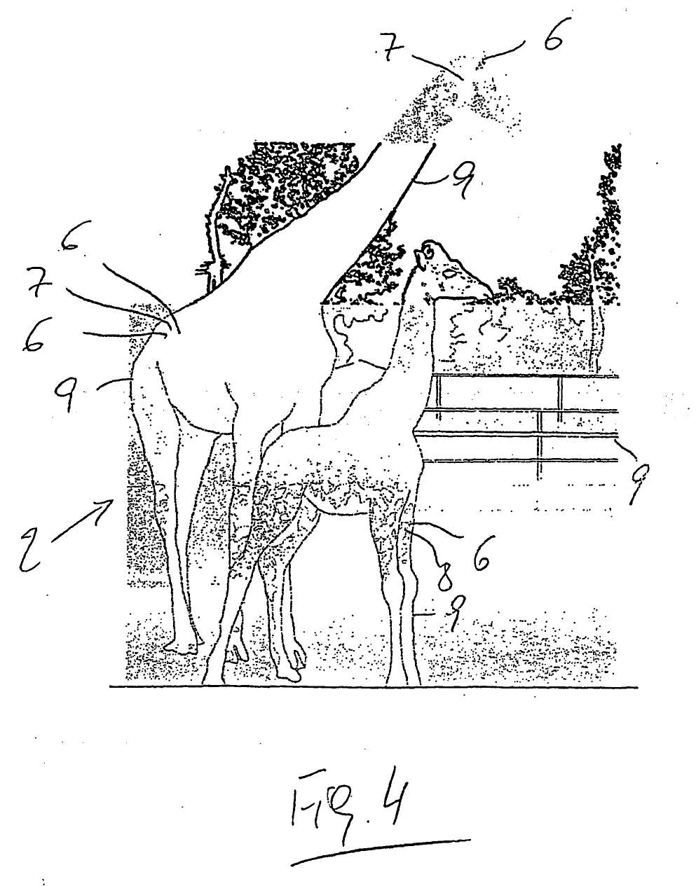

FIG. 3 shows an original painting corresponding to the working copy according to FIG. 2 and

FIG. 4 shows a combined working copy.

FIG. 2 shows a detail from a painting sheet according to the present invention. This painting sheet has a carrier 1 on which there is a working copy 2 to be painted. FIG. 3 shows an original painting 5. In terms of the basic illustration of the design, the original painting 5 and the working copy 2 are identical. As compared with the working copy 2, in addition to the basic illustration the original painting 5 of the design also further has those components of the design which are to be supplemented in the working copy 2 by the user of the painting sheet. These components can be, for example, colors, shadows and so on.

The design of the copy 2 and original 5 can have a number of components. In the example shown in FIG. 2, the design of the working copy 2 comprises an image 3 as one of the components of the design. This pictorial component 3 of the working copy 2 to be painted, used in the present case, is the image of a giraffe head. The design of the copy 2 and original 5 in the present example further comprises a second component 4, namely a series of characters. The example of such a series of characters 4 used is the word giraffe. It goes without saying that the series of characters 4 can also contain numbers or other characters in addition to letters. Such a series of characters 4, in addition to the pictorial component 3 of the design to be painted in the copy 2 or original 5, can also be a pure explanation, as is the case in FIGS. 2 and 3. Alternatively, the series of characters 4 can likewise serve and be designed as a component of the working copy 2 to be painted.

The respective component or at least the image component 3 of the design of the working copy 2 has at least one area 6 (FIG. 4), which serves and is designed as a painting base. The user of the painting sheet applies the color or the colors or other painting symbols to this base 6 and, for this reason, this area or partial area 6 is referred to as the painting base. The user of the painting sheet applies the color or the colors or other painting symbols to the painting base 6 as far as possible as predefined by the corresponding area in the original painting 5. In FIGS. 2 to 4, the respective design has a plurality of aforementioned painting bases 6. In this case, the working copy 2 has a whole number of painting bases or partial areas 6, whose composition can be different. The type of painting bases 6 determines the design of the respective component 3 or 4 of the working copy 2. The painting base 6 can, however, also cover the entire area of the working copy 2 as a coherent area, or the painting base 6 can assume only one section of the area of the working copy 2.

The color of the painting base or the painting bases 6 is lighter or paler as compared with the color in the corresponding areas of the original painting 5 (FIG. 3). The painting base 6 can have not only half-tones but also shadows and so on. The partial areas 6 are lightened according to the invention, and the combination of the same reproduces the design to be treated in the working copy 2.

If a painting base 6 extends coherently over the entire area of the working copy 2, then the margin or the margins of these painting bases 6 determine the contour of the component 3 or 4 of the design 2 to be painted or to be treated. If the working copy 2 or the components 3 or 4 of the same have painting bases 6 located beside one another and spaced apart from one another as partial areas, then the outer contour of the component 3 or 4 of the working copy 2 is defined by the marginal sections of the individual painting bases 6 lying in the region of the outer margin of the component 3 or 4 of the working copy 2. This contour line of the relevant component 3 or 4 of the working copy 2 is not a coherent line, because of the spaced-apart painting bases or partial areas 6. If the working copy 2 or the components 3 or 4 of the same have painting bases 6 lying beside one another and spaced apart from one another as partial areas, then there are gaps 7 between the respectively adjacent partial areas 6 of the design of the component 3 or 4 (FIG. 4). The color of the carrier 1 of the working copy 2 can be seen in the region of these gaps 7 between the respectively adjacent painting bases 6 of the design.

It goes without saying that the component 3 or 4 to be painted in the working copy 2 can be combined with further contents or designs (not illustrated), which are not lightened. These designs can be located on the same carrier 1, beside the component 3 or 4 to be painted in the working copy 2. For reasons of simplicity, there is merely a single word beside the image component 3 in FIG. 2. However, it should be clear that an entire text can also be located beside the lightened image component 3 of the design 2 and, under certain circumstances, can also comprise numbers or other symbols and which represents a further component of the design 2. However, it is also possible for the accompanying text 4 likewise designed to be lightened, so that such a text 4 can also represent one of the components of the working copy 2 of the present painting sheet. Consequently, the design of the working copy 2 contains at least one image 3 and/or at least one character or a series of characters 4.

Although FIG. 3 shows the same giraffe head as in FIG. 2, it is in the design as an original painting or as a target image. The target image is that image which is to be achieved by painting the working copy 2 to be processed in accordance with FIG. 2.

For different reasons, a painting base 6 or groups of painting bases 6 may have borders. such borders are provided with the aid of lines. The design of the working copy 2 in FIG. 4 comprises, inter alia, an adult giraffe and a giraffe that is still small. For example, in the region of the front leg of the small giraffe, the respective painting base 6 is bordered with the aid of an intrinsically closed line 8 in each case. In order to illustrate the contours of the sections of the working copy 2 that are designed to be lightened, use can be made of lines 9. Such contour lines 9 can also be used to illustrate those components of the design of the respective working copy 2 which, from the point of view of the painting exercise, are of no interest. In the case illustrated in FIG. 4, such contour lines 9 are used, inter alia to illustrate railings.

The present invention also makes it possible to design individual sections of the working copy 2 differently. In the upper region of FIG. 4, the giraffe head has neither marginal lines 8 nor contour lines 9, but only the painting base areas 6 and the gaps 7 between them. The neck region of the large giraffe has only contour lines 9, while the region of the body of the giraffe has both the painting base areas 6 and gaps 7 between them and also contour lines 9. These forms of illustration can be combined, in each case according to the situation.

The original painting 5 can be located beside the working copy 2 to be painted on the same carrier 1, or the original painting 5 can also be located on a separate carrier (not illustrated). A plurality of carriers 1, that is to say for example sheets of paper with the copy 2 and original 5 can be bound to form an exercise book or a book, a painting exercise book or a painting book being produced. If the original painting 5 is located on a different sheet than the working copy 2, then the painting sheet can be used, for example, in a competition in which a number of persons taking part in this competition paint the working copy according to their own imagination. By virtue of the fact that the copies 2 and originals 5 also permit or enable half-tones, shadows and so on, the competition can lead to manifold and interesting results.

The painting sheet may be produced, for example, by an initial design, for example an image, being digitized. This digitization of the initial design can be carried out by scanning, for example. After that, the digitized design is expediently stored. This digitized design can be used to produce the original painting 5.

Furthermore, the digitized design can be processed in such a way that it is paler or lighter than the original painting 5. The design processed in this way serves as the working copy 2. In order to achieve this working copy 2, the digitized design can be lightened with the aid of image processing software. In addition, the number of colors used in the initial design can be reduced. Alternatively, the colored initial design can be converted into a black and white image or into gray tones. The colors of the digitized design or of partial areas of the same can also be changed and their contrast can be intensified or weakened. In this phase of the production process, the contours of the entire digitized design or of partial areas 6 of the same can be redrawn with lines. Inside or beside the contour lines 8 and 9 there is the respective content of the design, inter alia reproduced with a lightened color, while outside the contour lines, the color of the carrier 1 can be seen. The contours 8 and 9 of the entire digitized design or of partial areas 6 of the same can, however, also be changed in this production phase. It is also possible to retouch the digitized design, that is to say to replace partial areas of the design by other partial areas, to remove partial areas from the image, to mix two or more images and so on, as can be seen, for example, from FIG. 4.

In the simplest case, the digitized design is converted into gray tones and then lightened. As a result, a half-tone image is produced in a simple way, it still being possible for more intense and less intense shadows still to be detected easily in this image. Furthermore, it is possible to convert the digitized image into gray tones, to lighten them and to operate with reverse colors (negative colors). Finally, it is also possible to leave the colors of the individual partial area of the design and only to make these lighter. The copies for painting, that is to say the working copies 2 and the original paintings 5, can also be stored and marketed in this form. This storage can expediently be carried out on a floppy disk, which can be marketed. It goes without saying that the copies 2 and originals 5 present in a digital form can also be marketed online. The user can initially print out the digitized copies 2 and originals 5 obtained, in order then to be able to paint these later.

The conversion into a black and white image, lightening, scanning the image and the conversion into negative colors may likewise be produced by known photographic ways, so that the areas to be painted can also be produced in the conventional, non-electronic manner.

The previous description assumes that the content of the design in the original painting 5 was identical with the content of the design in the working copy 2. However, it is also possible for the original painting to have further pictorial elements as compared with the working copy 2, which are only to be entered into the working copy 2 by the user of the painting sheet and which then are possibly to be painted.

1. A painting sheet comprising a carrier for at least one design, which serves as a working copy to be painted, characterized in that the working copy (2) has at least one area (6) which serves as a basis for the painting and which is paler or lighter than the corresponding area in the painted or finished design.

2. The painting sheet as claimed in claim 1, characterized in that an original painting (5) is provided, in that the content of the design in the original painting (5) is identical to the content of the design in the working copy (2), or in that the original painting (5) can have further pictorial elements which have to be entered into the working copy (2).

3. The painting sheet as claimed in the preceding patent claims, characterized in that the lightened painting base (6) is designed as a half-tone copy for painting.

4. The painting sheet as claimed in the preceding patent claims, characterized in that a line (8) extends at least along one section of the margin of the painting base (6).

5. The painting sheet as claimed in patent claim 1, characterized in that at least one line (9) is provided, which is intended to illustrate the contour of the design.

6. The painting sheet as claimed in the preceding patent claims, characterized in that the design or the working copy (2) has at least one pictorial component (3) and/or a series of characters (4) as a further component.

7. The painting sheet as claimed in the preceding patent claims, characterized in that there is at least one design which is not lightened beside the lightened painting base (6).

8. A method for producing the painting sheet as claimed in patent claim 1, characterized in that an initial design is digitized, and in that the digitized design is processed in such a way that it is paler or lighter than the design to be achieved by painting this pale image content.

9. The method as claimed in patent claim 8, characterized in that the digitization of the initial design is carried out by scanning, and in that the design achieved in this way is further processed by processing software.

10. The method as claimed in patent claim 8, characterized in that the digitized and lightened design is stored on a storage means, for example on a floppy disk.
